(19) United States
(12) Patent Application Publication
(10) Pub. No.: US 2012/0280849 A1
(43) Pub. Date: Nov. 8, 2012

(54) METHOD OF USING GROUND PENETRATING RADAR TO DETECT CORROSION OF STEEL BARS IN FERROCONCRETE COMPONENTS

(76) Inventors: Che-Way CHANG, Hsinchu city (TW); Chen-Hua Lin, New Taipei City (TW)

(21) Appl. No.: 13/182,105

(22) Filed: Jul. 13, 2011

(30) Foreign Application Priority Data
May 5, 2011 (TW) 100115837

(51) Int. Cl. G01S 13/89

(52) U.S. Cl. 342/22

(57) ABSTRACT

The present invention discloses a method of using ground penetrating radar to detect corrosion of steel bars in ferroconcrete components. The method comprises the following steps. Firstly, a ground penetrating radar is used to emit an electromagnetic wave toward a ferroconcrete component. Then, a reflected electromagnetic wave is received. The reflected electromagnetic wave is calculated to obtain characteristic parameters from the interface of the steel bar and the concrete, wherein the characteristic parameters includes reflection electric potential, specific resistance and corresponding specific electric current from the interface. Reference characteristic data which include reference thicknesses of the concrete versus reference reflected electric potential, specific resistance and corresponding specific electric current from the interface are provided. The obtained interface characteristic parameters and the thickness of the concrete are compared with the reference characteristic data to derive the corrosion condition of steel bars in the ferroconcrete component.

### BACKGROUND OF THE INVENTION

1. Technical Field

The present invention relates to a method of inspection by using the ground penetrating radar, and more particularly, to a non-destructive inspection method.

2. Description of Related Art

Ferroconcrete is often used for building up architectures, bridges, and water conservancy constructions, etc. It is poured concrete containing steel bars or metal netting. However, in Taiwan, the subtropical climate with high humidity makes the steel bars in the ferroconcrete corroded easily.

At first, the steel bars are coated with a layer of passive film to protect the steel bars from being corroded. But after being in the environment with high humidity for a long time, the coated passive film will be destructed gradually, and then the steel bars will be corroded, too. Once the steel bars are corroded, their volume will be expanded. The expanded steel bars will press the concrete around them and then crack the concrete to make crevices extending to the surface of the ferroconcrete. The crevices will become paths for the deleterious substance to enter and reach the steel bars such that more steel bars will be corroded. The corroded steel bars will lose load bearing strength and cannot bind with the concrete well, thereby the structure with the corroded steel bars will lose the durability.

Recently, climatic anomalies and natural disasters appear often. The architectures, bridges and water conservancy constructions are unable to resist the pounce of the Mother Nature, let alone those constructions with corroded steel bars, they can do nothing but collapse. Therefore, various inspection instruments for detecting the corrosion of the steel bars are developed. For example, in the often used electrochemical methods, there are half-cell potential method, corrosion current method and linear polarization method, etc. Before using the fore-mentioned methods, it is needed to spread water on the detected object to lower the resistance of it for detecting the corrosion condition of the steel bars. Those methods suffer from variances of the detection conditions and those methods mostly belong to semi-destructive inspection method. There are other inspection methods for detecting corrosion of steel bars disclosed in the patent database as below.

Taiwanese patent number 1265287 discloses an inspection method for detecting corrosion of steel bars by locating the Bragg grating at appropriate place of the steel bars. But when this method is applied to the well formed ferroconcrete, it is needed to destruct the ferroconcrete to expose the steel bars. Otherwise, it is needed to dispose the sensor with the grating before the ferroconcrete is formed; in this case, the sensor will have expansion or contraction because of the affection of the temperature changes from the environment such that it will conduct error inspection result.

Taiwanese patent number 1317013 discloses an inspection instrument for detecting defects and corrosion of steel bars. This invention provides a non-destructive inspection to prevent from neither breaking up the ferroconcrete component nor suffering from the abnormal working of the sensor in the ferroconcrete. But the radioactive ray with high penetrability is used in the inspection. When the inspection is conducted, the people around the detected object will be in danger because of being exposed to the radioactive ray with high energy.

Therefore, an improved non-destructive inspection method for detecting corrosion of steel bars is needed in this field of industry to resolve the problems in the prior arts for keeping the integrity of the detected ferroconcrete structure and preventing from using the radioactive rays, and further more to have higher inspection efficiency and stable inspection result.

### SUMMARY OF THE INVENTION

To overcome the shortcomings of the prior arts mentioned above, the present invention provides a method of using ground penetrating radar to detect corrosion of Steel bars in ferroconcrete components.

The method comprises the following steps. Firstly, a ground penetrating radar is used to emit an electromagnetic wave toward a ferroconcrete component. Then, a reflected electromagnetic wave is received. The thickness of the concrete, which means the shortest distance from the surface of the ferroconcrete component to the steel bar, is obtained. The reflected electromagnetic wave is calculated to obtain characteristic parameters from the interface of the steel bar and the concrete, wherein the characteristic parameters includes reflection electric potential, specific resistance and corresponding specific electric current from the interface. Reference characteristic data which include reference thicknesses of the concrete versus reference reflected electric potential, specific resistance and corresponding specific electric current from the interface are provided. The obtained interface characteristic parameters and the thickness of the concrete are compared with the reference characteristic data to derive the corrosion condition of steel bars in the ferroconcrete component.

Accordingly, the primary object of the present invention is to provide a method of using ground penetrating radar to detect corrosion of Steel bars in ferroconcrete components, wherein the method depends on the physical characters of the electromagnetic wave such that it can be conducted without destructing the ferroconcrete to expose the steel bars. This is a non-destructive inspection method to keep the integrity of the ferroconcrete component, and the result of the inspection has high stability.

Another object of the present invention is to provide a method of using ground penetrating radar to detect corrosion of Steel bars in ferroconcrete components, wherein the method depends on the physical characters of the electromagnetic wave such that the corrosion condition is decided by analyzing the potential and current difference carried out by the reflected electric potential and the corresponding specific electric current of the electromagnetic wave reflected from the interface.

Still another object of the present invention is to provide a method of using ground penetrating radar to detect corrosion of Steel bars in ferroconcrete components, wherein the method depends on the physical characters of the electromagnetic wave without radiant pollution and it can detect the corrosion condition without extra sensor disposed inside the ferroconcrete component.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a flowchart illustrating a method of using ground penetrating radar to detect corrosion of steel bars in a ferroconcrete component according to a preferred embodiment of the present invention;

FIG. 2A is a schematic view which illustrates the method to use ground penetrating radar to inspect the ferroconcrete component according to a preferred embodiment of the present invention;

FIG. 2B is a schematic view which illustrates the transmission path of the electromagnetic wave through the interface I and II;

FIG. 3A is a chart disclosing experimental results of reflected electric potentials from the corrosion interface of the steel bars in different thicknesses of the concrete;

FIG. 3B is a chart disclosing experimental results of specific resistances from the corrosion interface of the steel bars in different thicknesses of the concrete;

FIG. 3C is a chart disclosing experimental results of corresponding specific electric current from the corrosion interface of the steel bars in different thicknesses of the concrete;

FIG. 4A is a chart disclosing experimental results of corrosion potentials of the steel bars in different thicknesses (4 cm, 6 cm, 7 cm and 9 cm) of the concrete;

FIG. 4B is a chart disclosing experimental results of corrosion current density of the steel bars in different thicknesses of the concrete;

FIG. 5A is a chart illustrating normalized analysis of reflected electric potentials from the corrosion interface of the steel bars in different thicknesses of the concrete and different corrosion conditions;

FIG. 5B is a chart illustrating normalized analysis of specific resistances from the corrosion interface of the steel bars in different thicknesses of the concrete and different corrosion conditions;

FIG. 5C is a chart illustrating normalized analysis of corresponding specific electric current from the corrosion interface of the steel bars in different thicknesses of the concrete and different corrosion conditions;

FIG. 6A is the chart illustrating the normalized corrosion potential versus the normalized reflected electric potential in different corrosion condition ranges; and

FIG. 6B is the chart illustrating the normalized corrosion current density versus the normalized corresponding specific electric current in different corrosion condition ranges.

### DETAILED DESCRIPTION OF THE PREFERRED EMBODIMENT

The present invention discloses a method of using ground penetrating radar to detect corrosion of steel bars in ferroconcrete, wherein the theory of the ground penetrating radar is well known by those having ordinary skills in the art; therefore the description below will not describe it in detail. Also, the drawings referred to in the following description only schematically depict structures related to the technical features of the present invention and hence are not, and need not be, drawn to scale.

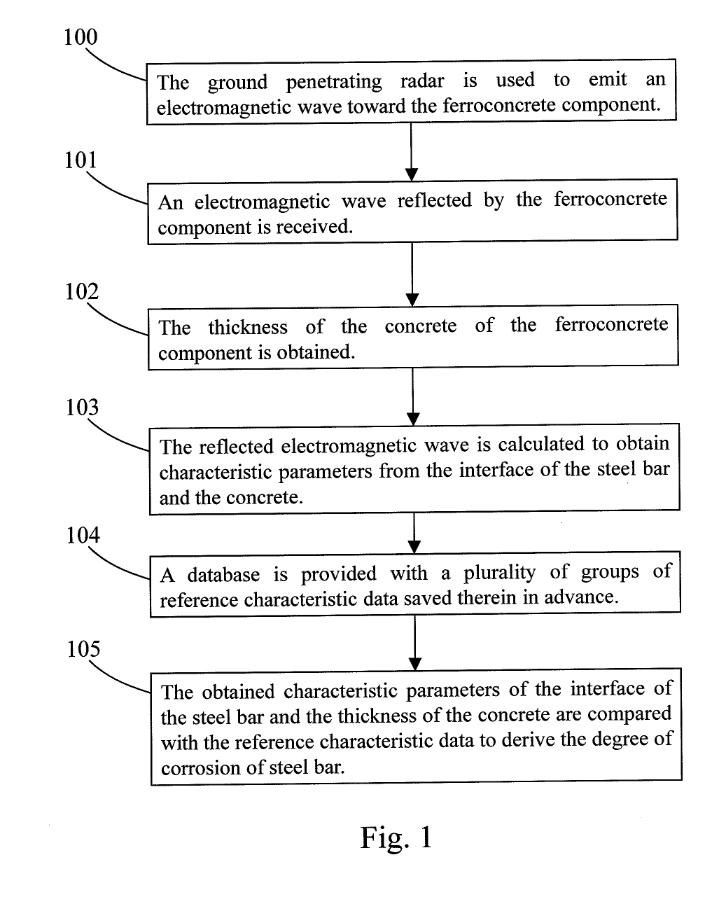

Referring to FIG. 1, it is a flowchart illustrating a method of using ground penetrating radar to detect corrosion of steel bars in a ferroconcrete component according to a preferred embodiment of the present invention. The method includes the following steps.

Step 100: The ground penetrating radar is used to emit an electromagnetic wave toward the ferroconcrete component.

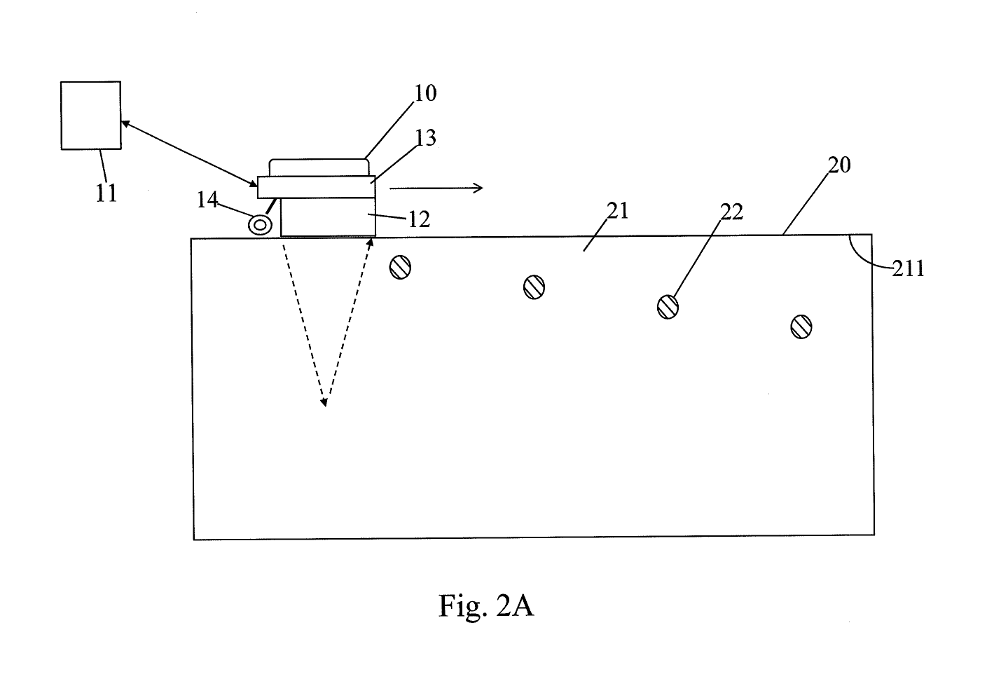

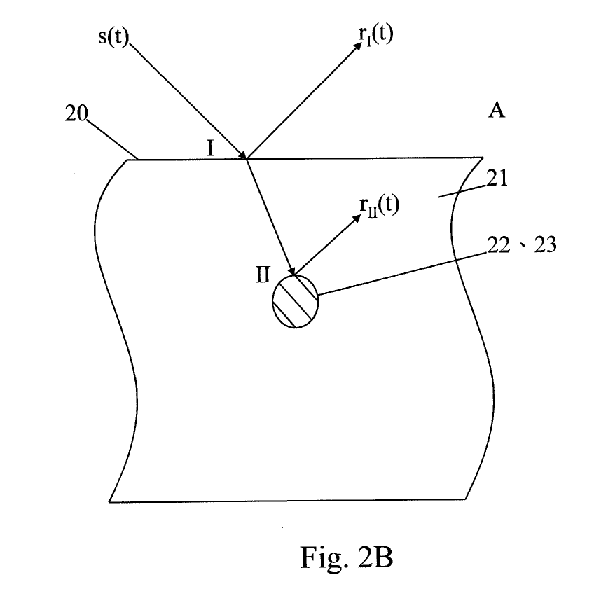

FIG. 2A is a schematic view which illustrates the method to use ground penetrating radar to inspect the ferroconcrete component. There are various kinds of ground penetrating radars on the market, but all of them include the main elements includes a controller 11, an antenna 12, a battery 13 and a measuring wheel 14. The controller 11 is used for receiving, calculating and saving signals and showing the signals through the connected monitor. The antenna 12 includes a transmitter (not shown) for emitting electromagnetic waves and a receiver (not shown) for receiving electromagnetic waves. The antenna 12 is connected with the controller 11 through an optic fiber to achieve the two-way signal transmission. Users can set up the frequency of the antenna 12 through the controller 11. The frequency setting affects the result of inspection. For example, while the frequency setting of the antenna is lower, the resolution of the inspection will be lower and the depth of inspection will be deeper; on the contrary, while the frequency setting is higher, the resolution of the inspection will be higher and the depth of inspection will be shallower. The battery 13 supplies the power of producing electromagnetic waves. It is noticeable that different frequency setting charges different power. Therefore, the users also need to consider of the capacity of battery while setting the frequency in order to prevent from having no power in the middle of the inspection. Nickel-cadmium battery or other rechargeable batteries on the market can be used as the fore-mentioned battery 13. The measuring wheel 14 rolls with the movement of the antenna 12, wherein the measuring wheel 14 can be switch of antenna 12 and can also measure the inspecting distance of the antenna 12.

Ferroconcrete component 20 with steel bars 22 embedded in the concrete 21 is provided. The dimensions of length, width, height of the ferroconcrete component 20 are 165 cm, 15 cm and 60 cm (165 cm×15 cm×60 cm). The steel bars of grade 6 (according to the CNS (Chinese National Standard) 560 which defines the standards of the steel bars used for the ferroconcrete) are used in the preferred embodiment. The antenna 12 of the ground penetrating radar 10 is pulled along the surface 211 of the concrete 21 to inspect the corrosion condition of the steel bars 22 which are embedded inside.

When the ground penetrating radar 10 and the ferroconcrete component 20 are ready, the user can pull the ground penetrating radar 10 along the surface 211 of the concrete 21. The controller 11 of the ground penetrating radar 10 will send signals to the antenna 12 depending on the setting of the user, and then the antenna 12 will emit an electromagnetic wave toward the ferroconcrete component 20.

Step 101: An electromagnetic wave reflected by the ferroconcrete component 20 is received.

When the electromagnetic wave confronts the steel bar 22, it will be reflected at the interface of the steel bar 22 and the concrete 21.

Step 102: The thickness of the concrete of the ferroconcrete component is obtained. The thickness of the concrete means the shortest distance from the surface 211 of the ferroconcrete component 20 to the steel bar 22.

For example, steels bars 22 are respectively embedded at the thicknesses of 4 cm, 6 cm, 7 cm and 9 cm of the concrete 21. The thickness of the concrete 21 also means the depth of the embedded steel bar. In order to use identical term in the specification, the thickness of the concrete 21 is used in the following description. The fore-mentioned thickness of the concrete 21 means the shortest distance from the surface 211 of the concrete 21 of the ferroconcrete component 20 to the steel bar 22.

Step 103: The reflected electromagnetic wave is calculated to obtain characteristic parameters from the interface of the steel bar and the concrete. The characteristic parameters include reflected electric potential, specific resistance and corresponding specific electric current from the interface. Then, the characteristic parameters are saved in the controller 11.

Step 104: A database is provided in the controller 11. There are a plurality of groups of reference characteristic data saved in the database in advance. Each group includes reference reflected electric potential, specific resistance and corresponding specific electric current from the interface versus reference concrete thickness and condition of corrosion of the steel bar.

It is noticeable that the fore-mentioned reflectance of the interface of the steel bar, the electric potential of the incident electromagnetic waves and power of the incident electromagnetic waves. Besides, the specific resistance of the interface between the steel bar and the concrete is obtained by calculating with the magnetic field and electric field of the reflected electromagnetic wave. The condition of the corrosion of the steel bars is defined into 3 degrees of slight corrosion, middle corrosion and severe corrosion.

Step 105: The obtained characteristic parameters of the interface of the steel bar and the thickness of the concrete are compared with the reference characteristic data to derive the degree of corrosion of steel bar in the ferroconcrete component 20.

The reference characteristic data in the database can be further normalized by referring to the thickness of the concrete.

The fore-mentioned calculation process has been built in the controller 11. As soon as receiving the signals, the controller 11 automatically conducts the calculation. The calculation with the characteristic parameters of the reflected electric potential, specific resistance and corresponding specific electric current from the interface of the steel bar will be further described below.

The fore-mentioned reflected electric potential is obtained by calculating with the reflectance, the electric potential and power of the incident electromagnetic waves. The specific calculation is described below.

FIG. 2B is a schematic view which illustrates the transmission path of the electromagnetic wave through the interface I and II. In this embodiment, the ground penetrating radar 10 emits an electromagnetic wave pass through the media, wherein the media include air A, the concrete 21, and the steel bar 22 or corroded steel bar 23. The interface I is between the air and the concrete, the interface II is between the steel bar (or the corroded steel bar) and the concrete. The reflected electric potential from the interface of concrete and steel bar is received. The reflected electric potential is affected by the interfaces, the electric current and resistance of the electromagnetic wave.

The reflection action of the electromagnetic wave passing through the ferroconcrete is built up depending on ratio of the reflected electric potential and the incident electric potential. R_{I} is the reflectance of the interface I, and it is defined as the equation below.

R_{I}=r_{I}(t)/s(t)

In this equation, r_{I}(t) is the reflected electric potential reflected by the interface I, which is between the air and the concrete; s(t) is the incident electric potential of the interface I; R_{I} is the reflectance of the interface I. So the reflected electric potential which is reflected by the interface I between the air and the concrete f can be defined by the following equation.

r_{I}(t)=R_{I}·s(t)

Another reflected electromagnetic wave can be occurred while the incident electromagnetic wave passing by the second interface (interface II). R_{II} is the reflectance of the interface II, and it is defined as the equation below.

R_{II}=r_{II}(t)/s(t)·wᵢ

So the reflected electric potential which is reflected by the interface II can be defined by the following equation.

r_{II}(t)=R_{II}·s(t)·wᵢ

In this equation, r_{II}(t) is the reflected electric potential reflected by the interface II, which is between the concrete and the steel bar (or corroded steel bar); R_{II} is the reflectance of the interface II; s(t) is the incident electric potential of the interface II; wᵢ is incident power, wᵢ=(1−R_{I}²), R_{I}² is the reflected power of the interface I.

The specific resistance of the interface between the steel bar and the concrete is obtained by calculating with the magnetic field and electric field of the reflected electromagnetic wave, and it is defined as the equation below.

η=\sqrt{μ/ε}(Ω)

In this equation, μ=μ₀×μ_{γ}, wherein μ₀ is permeability of free space and μ₀=4π×10⁻⁷(H/m), μᵣ is relative permeability, and μᵣ=1, ε=ε₀×ε_{γ}, wherein ε₀ is permittivity of free space, and ε₀=8.85×10⁻¹²(F/m), εᵣ is relative permittivity, and εᵣ=1.

The reflected electric potential and the specific resistance of the interface can be obtained by the calculations fore-mentioned. The specific electric current of the interface can be obtain from the ratio of the reflected electric potential and the specific resistance as the equation below.

I=r_{I} /η

In the equation, r_{II} is the reflected electric potential of interface II, η is the specific resistance of the interface, I is the specific electric current of the interface.

An example of experiment is further provided to explain the characters of the present invention.

A. Content of the experiment: There are an experimental group and a control group in the experiment. In the experimental group, a speed-up steel bar corrosion experiment is conducted and the degree of corrosion of the steel bar is inspected by the ground penetrating radar; while in the control group, a speed-up steel bar corrosion experiment is conducted and the degree of corrosion of the steel bar is inspected by a half-cell potentiometer and a galvanometer.

I. The Experiment Content of the Experimental Group:

a. The Speed-Up Steel Bar Corrosion Experiment:

In this experiment, a direct current power supply is used to provide electric current for speeding up the corrosion of the steel bar. The ferroconcrete is disposed on a titanic net, and is partially immersed in the water. But it is noticed that the steel bars don't contact the water. The positive pole of the power supply is connected to the steel bar and the negative pole is connected to the titanic net while the power supply is supplying a direct electric current.

b. Inspection of Corrosion of the Steel Bar by Using Ground Penetrating Radar:

While the speed-up steel bar corrosion experiment is conducted, the degree of corrosion of the steel bar is inspected by the ground penetrating radar. The steel bars in the ferroconcrete components with different thicknesses (4 cm, 6 cm, 7 cm, and 9 cm) are scanned by the ground penetrating radar during the process of speeding-up corrosion (0˜408 hrs). The characteristic parameters of slight corrosion, middle corrosion and severe corrosion are gotten in different time points in the speeding-up corrosion process.

II. The Experiment Content of the Control Group:

a. The Speed-Up Steel Bar Corrosion Experiment:

In this experiment, a direct current power supply is used to provide electric current for speeding up the corrosion of the steel bar. The ferroconcrete is disposed on a titanic net, and is partially immersed in the water. But it is noticed that the steel bars don't contact the water. The positive pole of the power supply is connected to the steel bar and the negative pole is connected to the titanic net while the power supply is supplying a direct electric current.

b. Inspection of Corrosion Potential of the Steel Bar by Using Half-Cell Potentiometer:

While the speed-up steel bar corrosion experiment is conducted, the corrosion potential of the steel bar is inspected by the half-cell potentiometer. The reference electrode of the half-cell potentiometer is Cu/CuSO₄. The inspection is conducted by referring to the corrosion potential of steel bar depending on ASTM C876. The steel bars in the ferroconcrete component with different thicknesses (4 cm, 6 cm, 7 cm, and 9 cm) are scanned by the half-cell potentiometer during the process of speeding-up corrosion (0˜408 hrs).

c. Inspection of Corrosion Current of the Steel Bar by Using a Galvanometer:

While the speed-up steel bar corrosion experiment is conducted, the corrosion current of the steel bar is inspected by the galvanometer. The reference electrode of the galvanometer is Ag/AgCl. The inspection is conducted by referring to the corrosion potential, current and corrosion speed of steel bar depending on ASTM C876-91. The steel bars in the ferroconcrete component with different thicknesses (4 cm, 6 cm, 7 cm, and 9 cm) are scanned by the galvanometer during the process of speeding-up corrosion (0˜408 hrs).

B. Result of the experiment: There are results of experimental group and control group respectively. In the experimental group, the reflected electric potential, specific resistance and corresponding specific electric current obtained from the steel bar corrosion experiment inspected by the ground penetrating radar are further analyzed. In the control group, the corrosion potential obtained by the half-cell potentiometer and the corrosion current density obtained by the galvanometer are further analyzed.

I. Analysis Result of the Experimental Group:

a. Analysis Result of the Reflected Electric Potential Obtained in the Inspection of Corrosion of the Steel Bar by Using Ground Penetrating Radar:

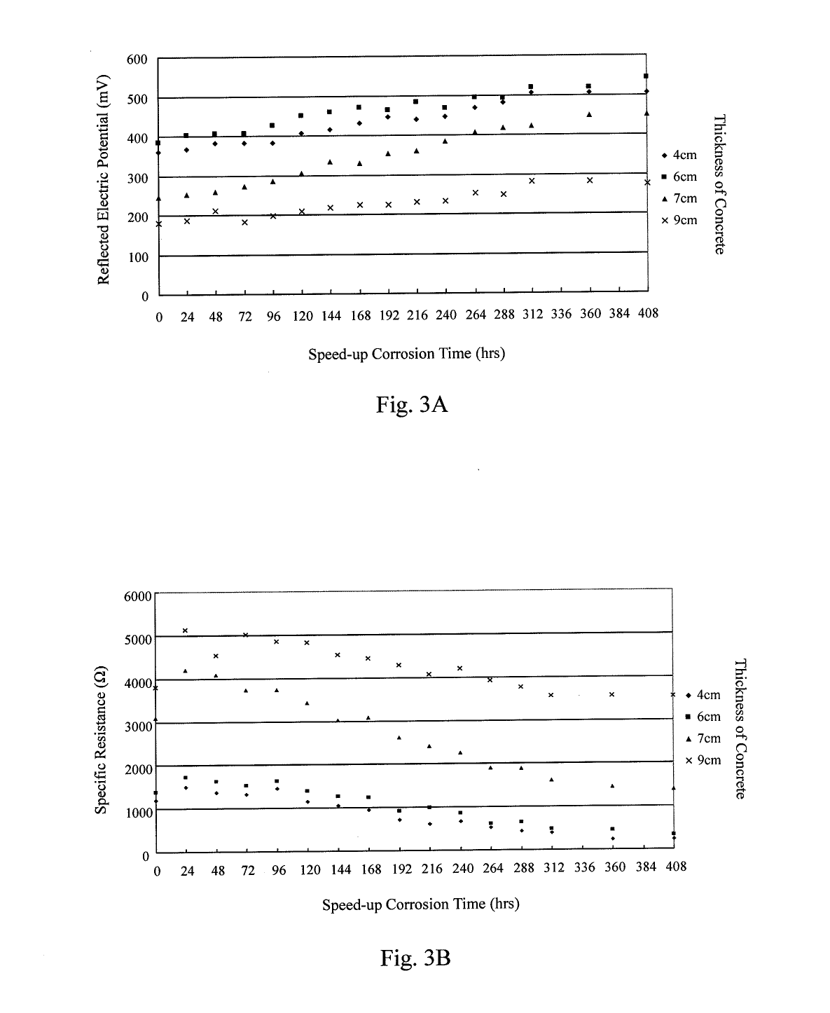

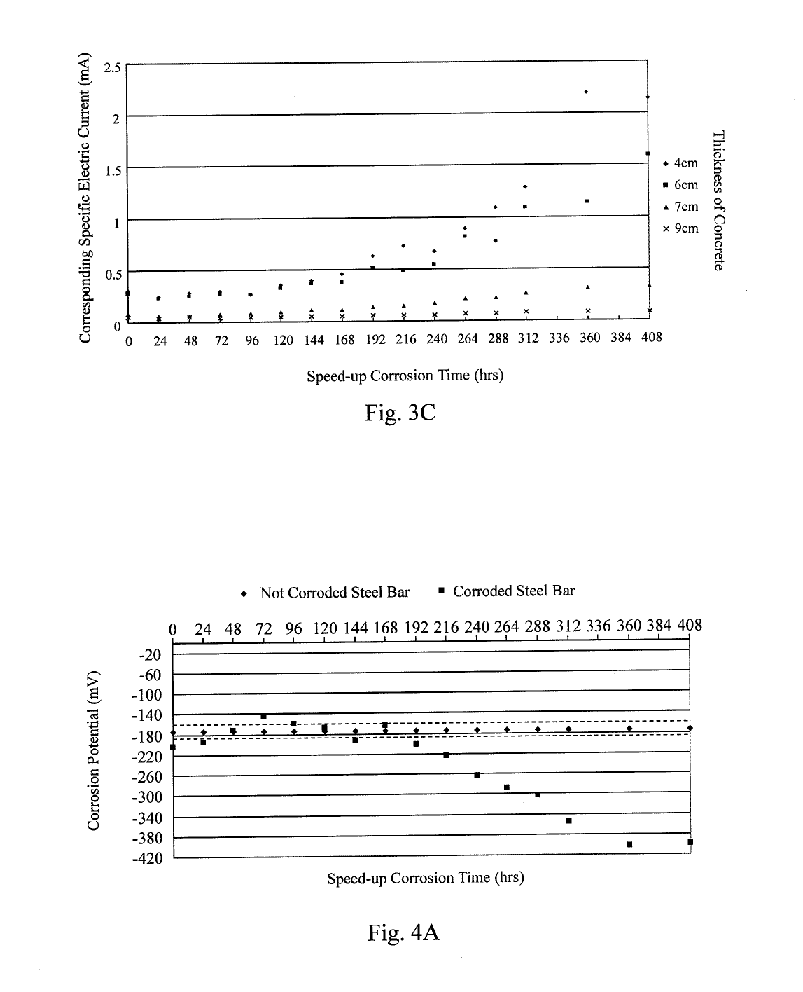

Referring to FIG. 3A, it is a chart disclosing experimental results of reflected electric potentials from the corrosion interface of the steel bars in different thicknesses of the concrete. From the result, the reflected electric potentials from the corrosion interface of the steel bars in different thicknesses of the concrete increase while the speed-up corrosion time increases. The values of the reflected electric potential growth from non-corrosion to severe corrosion in order of concrete thicknesses of 4 cm, 6 cm, 7 cm, and 9 cm are 160 mV, 201 mV, 215 mV and 174 mV. The steel bar located in the thickness of 7 cm is at the surface of the immersing water therefore the corrosion thereof is the most severe.

b. Analysis Result of the Specific Resistance Obtained in the Inspection of Corrosion of the Steel Bar by Using Ground Penetrating Radar:

Referring to FIG. 3B, it is a chart disclosing experimental results of specific resistances from the corrosion interface of the steel bars in different thicknesses of the concrete. From the result, in the early stage, the specific resistances from the corrosion interface of the steel bars increase while the thickness of the concrete increases. The values of the specific resistance in order of concrete thicknesses of 4 cm, 6 cm, 7 cm, and 9 cm are 1194Ω, 1385Ω, 3088Ω and 3808Ω. But with the speed-up corrosion time goes by, the values of the specific resistance decrease to 235Ω, 340Ω, 1395Ω and 3544Ω. It shows that when the corrosion of the steel bar becomes severer, the specific resistance of the corrosion interface of the steel bar becomes smaller.

c. Analysis Result of the Corresponding Specific Electric Current Obtained in the Inspection of Corrosion of the Steel Bar by Using Ground Penetrating Radar:

Referring to FIG. 3C, it is a chart disclosing experimental results of corresponding specific electric current from the corrosion interface of the steel bars in different thicknesses of the concrete. From the result, the corresponding specific electric currents from the steel bars in the thickness of 4 cm, 6 cm and 7 cm increase while the corrosion of the steel bars become severer. Comparing with the reflected electric potential and the specific resistance, the change of the corresponding specific electric current is more obvious. But the change of the corresponding specific electric current of the steel bar in the thickness of 9 cm is unobvious. It shows that when the thickness of the concrete is thicker, the change of the corresponding specific electric current is smaller though when the corrosion is severer.

II. Analysis Result of the Control Group:

a. Analysis Result of the Corrosion Potential Obtained in the Inspection of Corrosion of the Steel Bar by Using Half-Cell Potentiometer:

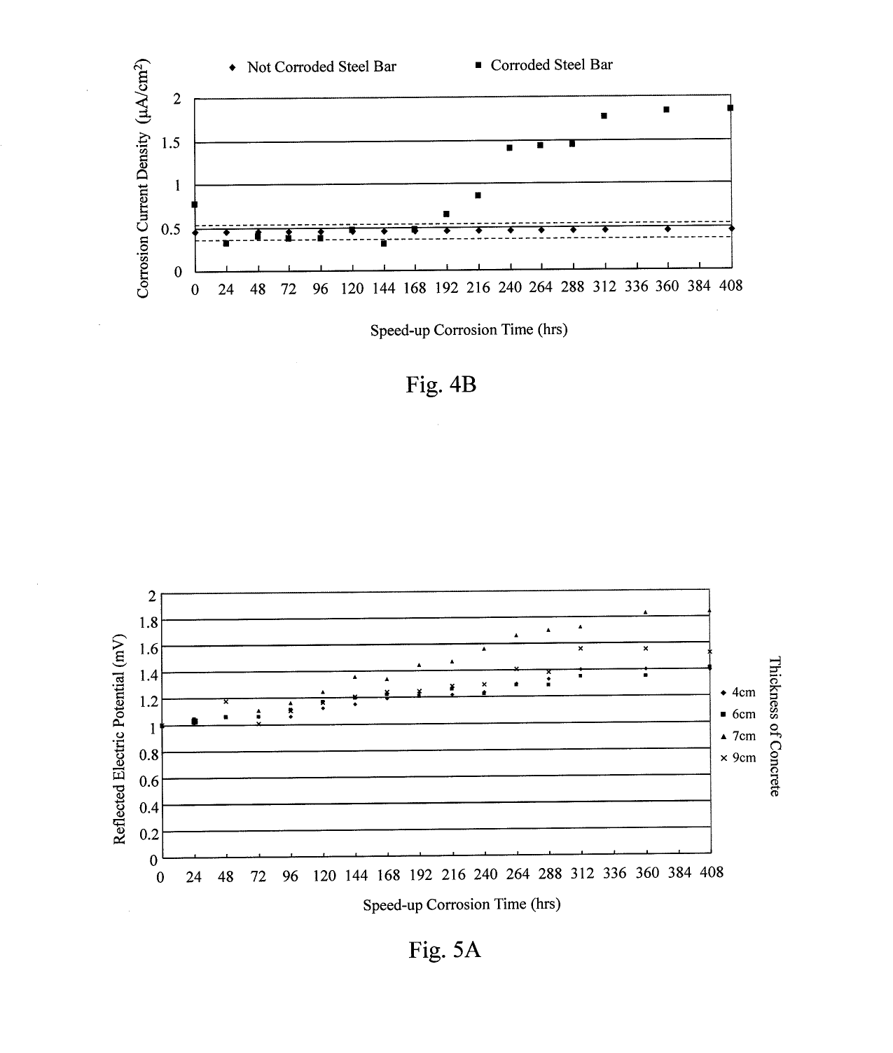

Referring to FIG. 4A, it is a chart disclosing experimental results of corrosion potentials of the steel bars in different thicknesses (4 cm, 6 cm, 7 cm and 9 cm) of the concrete. Also referring to Table. 1, it lists ranges of the conditions of corrosion, thicknesses of concrete, corrosion potentials relative to the reference electrode Cu/CuSO₄ and corresponding reflected electric potentials inspected by the ground penetrating radar. From the result, the initial corrosion potentials of steel bars in different thickness of concrete are around −200 mV, and the corrosion rate is below 10%. It is because that the steel bars are protected by the passive film covering thereon in the early stage. With the speed-up corrosion time goes by, after the passive film is destroyed, the corrosion potentials start decreasing obviously. The steel bars in different thicknesses of 4 cm, 6 cm, 7 cm and 9 cm are inspected, and it is found that all the corrosions are occurred from 144˜168 hours of the speed-up corrosion time. After 288 hours, the steel bars all reach severe corrosion condition.

TABLE 1

| | | | | reflected electric | |
|---|---|---|---|---|---|
| | | corrosion potentials | | potentials | |
| | | relative to the | | inspected by the | |
| Corrosion | Thickness | reference electrode | | ground penetrating | |
| Condition | of Concrete | Cu/CuSO₄ | | radar | |
| Corrosion Rate | 4 cm~9 cm | >−200 | mV | 0~79 | mV |
| Below10% | | | | | |
| Corrosion Rate | 4 cm~9 cm | −200~−350 | mV | 79~148 | mV |
| 10%~90% | | | | | |
| Corrosion Rate | 4 cm~9 cm | <−350 | mV | >148 | mV |
| Above 90% | | | | | |

b. Analysis Result of the Corrosion Current Density Obtained in the Inspection of Corrosion of the Steel Bar by Using the Galvanometer:

Referring to FIG. 4B, it is a chart disclosing experimental results of corrosion current density of the steel bars in different thicknesses (4 cm, 6 cm, 7 cm and 9 cm) of the concrete. Also referring to Table. 2, it lists the conditions of corrosion, thicknesses of concrete, corrosion current densities and corresponding specific electric currents inspected by the ground penetrating radar. From the result, the initial corrosion current densities of steel bars in different thickness of concrete are 0.7 μA/cm². The corrosion current density increases while the speed-up corrosion time increases. The corrosion current densities of steel bars in thickness of 4 cm, 6 cm and 9 cm increase obviously after 168 hours. However, the corrosion current density of steel bars in thickness of 7 cm increases obviously after 144 hours. It is found that the corrosions are occurred from 144˜168 hours of the speed-up corrosion time.

TABLE 2

| | | | Corresponding |
|---|---|---|---|
| Corrosion | Thickness | Corrosion Current | specific electric |
| Condition | of Concrete | Density(μA/cm²) | current(mA) |
| Passive state | 4 cm~9 cm | i_{corr} < 0.1 | I < 0.06 |
| Middle Low | 4 cm~9 cm | 0.1 < i_{corr} < 0.5 | 0.06 < I < 0.15 |
| Corrosion | | | |
| Rate | | | |
| Middle High | 4 cm~9 cm | 0.5 < i_{corr} < 1.0 | 0.15 < I < 0.58 |
| Corrosion | | | |
| Rate | | | |
| High Corrosion | 4 cm~9 cm | i_{corr} > 1.0 | I > 0.58 |
| Rate | | | |

III. Comparison of the Results of Experimental Group and Control Group:

Firstly, the characteristic parameters of different degrees of corrosion obtained from the experimental group are normalized. Then, the reference characteristic parameters and the corrosion potential/current obtained in the control group are also normalized.

a. Characteristic Parameters of Electromagnetic Wave Depending on Different Degrees of Corrosion:

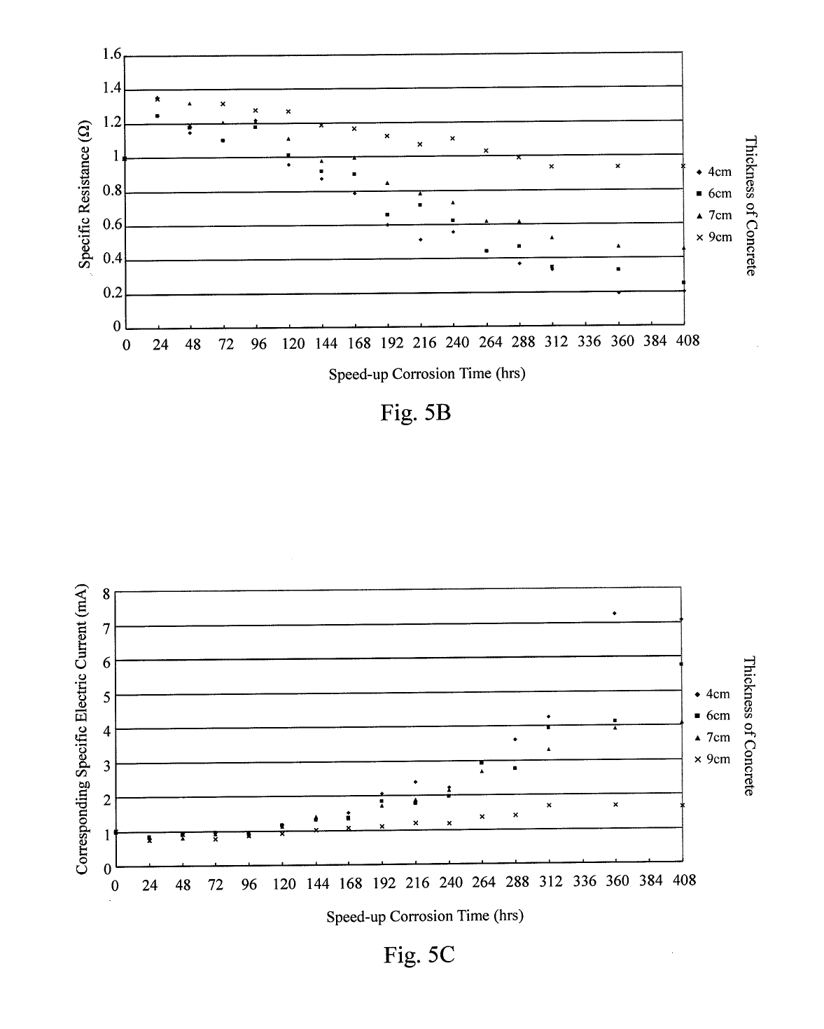

Referring to FIGS. 5A˜5C, the obtained characteristic parameters including reflected electric potential, specific resistance and corresponding specific electric current under different thicknesses of concrete and different decrees of corrosion are normalized. In other words, the characteristic parameters obtained by emitting electromagnetic wave toward the steel bars in the ferroconcrete components with different concrete thicknesses are normalized.

In the result, it shows that when the thickness of the concrete is thicker the specific resistance is higher, reflected electric potential is higher and the responding specific current is smaller. It shows that the corrosion interfaces of the steel bars with different thicknesses have similar physical phenomenon. When the obtained characteristic parameters including reflected electric potential, specific resistance and corresponding specific electric current under different thicknesses of concrete and different decrees of corrosion are normalized, it can be found that the corrosion of interface of steel bars in different thickness is in the same base. Depending to the FIGS. 5A˜5C, it shows that when the speed-up corrosion time goes by, the reflected electric potential increases with positive slope, specific resistance decreases with negative slope, and the corresponding current is the ratio of the fore-mentioned two. So that the change of the corresponding specific electric currents can be well understand by illustrated by curves.

b. Characteristic Parameters of Electromagnetic Wave Versus Corrosion Conditions of the Steel Bar Interface:

The reference data in the database including reflected electric potential, specific resistance, thickness of concrete and degree of corrosion of the steel bar are normalized relative to the corrosion potential/current. Then, the obtained characteristic parameters are qualitatively compared with the reference parameters to decide whether the characteristic parameters obtained by the ground penetrating radar in different time points belong to the range of slight corrosion, middle corrosion or severe corrosion.

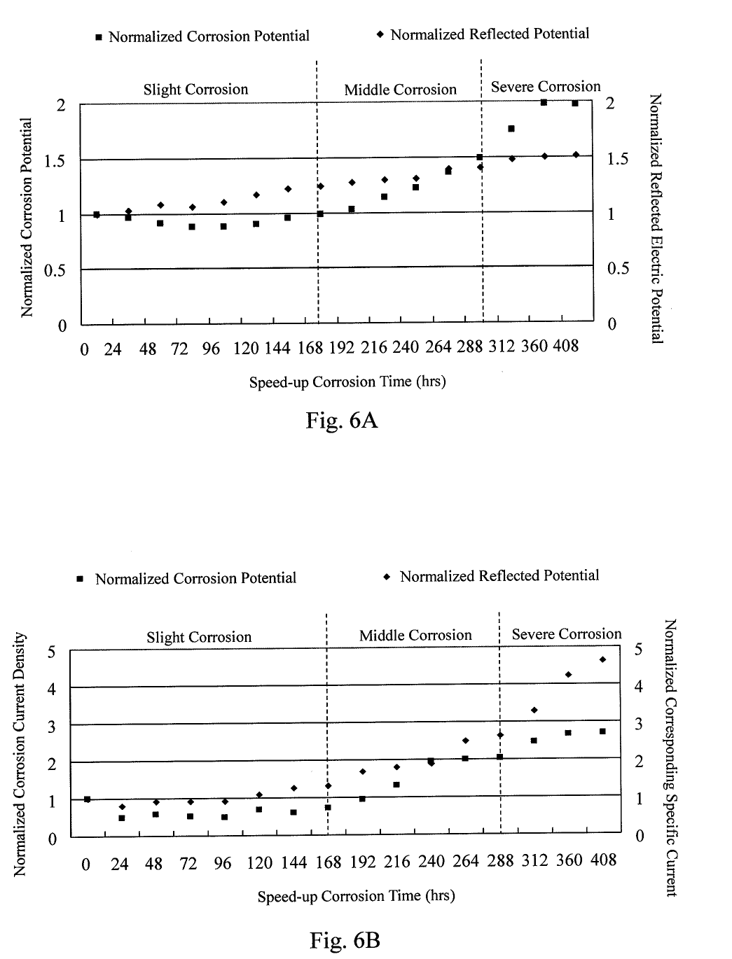

Referring to FIG. 6A, it is the chart illustrating the normalized corrosion potential versus the normalized reflected electric potential in different corrosion condition ranges. Before speed-up corrosion for 168 hours, the result of corrosion potential inspection is affected by the passive film covering the steel bar while the result of inspection by ground penetrating radar is not affected by the passive film. It shows that the inspection by using ground penetrating radar can react the corrosion of steel bar earlier than the prior art.

Referring to FIG. 6B, it is the chart illustrating the normalized corrosion current density versus the normalized corresponding specific electric current in different corrosion condition ranges. Before speed-up corrosion for 168 hours, the result of corrosion current density inspection is affected by the passive film covering the steel bar. Although the result of the corresponding specific electric current obtained by ground penetrating radar shows similar trend as the corrosion current density inspection, it has higher sensitivity than the corrosion current density inspection, since the corresponding specific electric current shows corrosion reaction from 96 hours. After speed-up corrosion for 168 hours, the steel bar reaches middle corrosion condition; and after speed-up corrosion for 288 hours, the steel bar reaches severe corrosion condition.

In summary, the present invention provides an inspecting method depending on the physical characters of the electromagnetic wave without radiation pollution. In the inspection the incident electromagnetic wave reaches the interface of the steel bars with different corrosion conditions, therefore, it can be conducted without destructing the ferroconcrete to expose the steel bars. This is a non-destructive inspection method to keep the integrity of the ferroconcrete component, and the result of the inspection has high stability. In the present invention, the inspection is conducted by receiving the reflected electromagnetic wave from the steel bars in different corrosion conditions, and extra sensor is not needed. Furthermore, the corrosion condition is decided by analyzing the potential difference carried out by the reflected electric potential of the electromagnetic wave and the specific resistance of the interface. The corrosion conditions of the steel bar can be detected and defined into slight corrosion, middle corrosion and severe corrosion. What is more, in the present invention, it is not needed to spread water on the surface of the ferroconcrete, the medium of the inspective object will not be affected, thereby the accuracy of the inspection can be further raised.

In the preferred embodiment, the characteristic parameters of steel bars with different thicknesses of concrete and different corrosion conditions are inspected by using ground penetrating radar. The radar emits electromagnetic wave to scan the ferroconcrete component and the reflected electric potential from the steel bar interface is obtained. It is noticeable that inspection of the reflected electric potential can find out the corrosion of the steel bar earlier than the inspection of half-cell potential can; and the inspection of responding specific current can find out the corrosion of the steel bar earlier than the inspection of corrosion current density can. Depending on the result, it shows that the inspection using ground penetrating radar has higher sensitivity than the half-cell potential inspection and corrosion current density inspection. What is more, the inspection using the ground penetrating radar can inspect the corrosion of the steel bars embedded in the ferroconcrete without destructing the surface of the ferroconcrete.

Although some particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. A method of using a ground penetrating radar to detect corrosion of a steel bar in a ferroconcrete component, the method comprising the following steps of
using the ground penetrating radar (10) to emit an electromagnetic wave toward the ferroconcrete component (20);
receiving a reflected electromagnetic wave reflected by the steel bar in the ferroconcrete component (20);
obtaining the thickness of the concrete which means the shortest distance from the surface (211) of the ferroconcrete component (20) to the steel bar;
calculating the reflected electromagnetic wave to obtain characteristic parameters from the interface of the steel bar and the concrete, wherein the characteristic parameters comprise reflection electric potential, specific resistance and corresponding specific electric current from the interface;
providing a database with a plurality of groups of reference characteristic data saved therein in advance, wherein each group of the reference characteristic data comprise reference reflected electric potential, specific resistance and corresponding specific electric current from the interface versus reference concrete thickness and condition of corrosion of the steel bar; and
comparing the obtained characteristic parameters of the interface and the thickness of the concrete with the reference characteristic data to derive the corrosion condition of the steel bar in the ferroconcrete component (20).

2. The method of using a ground penetrating radar to detect corrosion of a steel bar in a ferroconcrete component of claim 1, wherein the reflected electric potential is obtained by calculating with the reflectance of the interface of the steel bar, the electric potential of the incident electromagnetic waves and power of the incident electromagnetic waves.

3. The method of using a ground penetrating radar to detect corrosion of a steel bar in a ferroconcrete component of claim 1, wherein the specific resistance of the interface between the steel bar and the concrete is obtained by calculating with the magnetic field and electric field of the reflected electromagnetic wave.

4. The method of using a ground penetrating radar to detect corrosion of a steel bar in a ferroconcrete component of claim 1, wherein the reference degree of the corrosion of the steel bars is defined into 3 degrees of slight corrosion, middle corrosion and severe corrosion.

5. The method of using a ground penetrating radar to detect corrosion of a steel bar in a ferroconcrete component of claim 1, wherein the reference characteristic data in the database is further normalized by referring to the thickness of the concrete.
